(19) United States
(12) Patent Application Publication
(10) Pub. No.: US 2002/0064393 A1
(43) Pub. Date: May 30, 2002

(54) Frame connection structure in printer device

(76) Inventor: Hiroyuki Akimoto, Tokyo (JP)

Correspondence Address: FRISHAUF, HOLTZ, GOODMAN, LANGER & CHICK, P.C., 25th Floor, 767 Third Avenue, New York, NY, 10017, US

(21) Appl. No.: 09/768,550

(22) Filed: Jan. 24, 2001

(30) Foreign Application Priority Data
Feb. 2, 2000 (JP) 24651/2000
Oct. 31, 2000 (JP) 333788/2000

(51) Int. Cl. G03G 15/00

(52) U.S. Cl. 399/107

(57) ABSTRACT

To form a printer device having the framework which is connected to a plurality of frames, there are included a main frame, as a lower frame adjacent to a surface of a table, etc. on which the printer device is arranged, and a sub-frame which is separated from the main frame. The sub-frame is connected to the main frame at three points. A plurality of image formation units and a conveyer belt are supported by the sub-frame. Even if the main frame is tilted over one side or the other as a result of an external factor, such as a warped surface of the table, such unstable arrangement of the printer device has no effect on the sub-frame. Hence, the engine parts of the image formation units supported by the sub-frame can desirably function. In this structure of the printer device, positional deviation does not occur in image components to be printed, and high quality printing can be performed.

### BACKGROUND OF THE INVENTION

1. Field of the Invention

The present invention relates to a printer device which includes a lower body, and an upper body which can be opened away from and closed toward the lower body, and, more particularly, to a printer device having a connection structure for connecting a plurality of frames forming the framework of the printer device.

2. Description of the Related Art

Conventionally, a well-known printer device includes an image formation unit which is attachable to and detachable from the printer device, and comprises a lower body and an upper body which can be shifted upward from the lower body for the maintenance sake.

FIG. 13 illustrates an outside perspective view of a conventional monochrome printer device. In the illustration, a printer device 1 comprises a roof 2, which forms an upper body, and a lower body 3. The roof 2 includes a paper outputting section 5 from which papers are output onto the roof 2, and a paper outputting tray 6 for outputting papers one on top of another. The lower body 3 includes a front cover 7 which can be opened and closed in the front section of the lower body 2, and a paper cassette 8 which is detachable from and attachable to the lower body 3. An MPF (Multi Paper Feeder) tray 9 which can be contained in the lower body 3 is arranged on the right side of the printer device 1. An operational display section 4 for inputting information to the printer device 1 or for displaying the state of printer device 1 is arranged on the right upper side of the printer device 1.

In such a printer device 1, the roof 2 is opened in a direction shown with an arrow B centrically at a rotational axis A, when clearing a jam occurring in the printer device or carrying out maintenance operation. FIG. 14 shows a cross sectional view of the printer device together with the internal structure thereof. As illustrated in FIG. 14, the printer device 1 comprises: a paper cassette 8 which is detachable from and attachable to the printer device 1; a paper feeding roller 12 which sequentially feeds papers contained in the paper cassette 8; a pair of suspension rollers 13 which suspend a received paper and send the paper to an image formation section 11 at a redetermined timing, in association with a pair of paper outputting roller 18; a fixation unit 14 which fixes a toner image onto a paper; the pair of paper outputting rollers 18 (a driving roller 18a and a driven roller 18b) which output the paper onto which the toner image is fixed; and an operational display section 4 for performing various settings for the printer device 1 or displaying the state of the printer device 1.

In the image formation section 11, a charger 25 uniformly charges electric charges onto the circumferential surface of a photosensitive drum 23. A printing head 26 selectively exposes the circumferential surface of the photosensitive drum 23 based on printing data. The electric potential of a portion of the photosensitive drum 23, whose circumferential surface is exposed, is lower than that which is charged with electricity. Hence, an electrostatic latent image is formed on the circumferential surface of the photosensitive drum 23. A developing unit 27 transfers internally contained toner onto the low potential section of the photosensitive drum 23 through a developing roller 27a so as to develop the electrostatic latent image. A transfer unit 28 transfers the toner image on the photosensitive drum 23 onto a paper to be conveyed, with an electric field whose polarity is opposite to that of the toner.

The photosensitive drum 23, the charger 25, the developing unit 27, the transfer unit 28, a cleaner 24, etc. which are included in the image formation section 11 are included in the lower body 3, while the printing head 26 is arranged on the roof 2 as the upper body.

The roof 2 can be opened and closed centrically about a hinge section 15 in both directions as shown with arrows B and B′. At this time, the printing head 26 and the driven roller 18b are incorporated with the roof 2 so as to be opened and closed altogether. The roof 2 shown with a straight line in FIG. 14 is in the state where it is closed, while the roof 2 shown with a double dot chain line is in the state where it is opened. To keep the roof 2 opened, a body locking mechanism 16 is arranged. The locking mechanism 16 is composed of a hook 17a arranged on the lower body 3 and an engagement section 17b which is arranged on the roof 2 and engaged with the hook 17a.

The image formation section 11 mainly forms a cartridge CT as an image formation unit which is detachable from and attachable to the lower body 3. The cartridge CT includes the first cartridge CT1 comprising the photosensitive drum 23 and the cleaner 24, etc, and the second cartridge CT2 including the developing unit 27. The cartridge CT is dividable into the cartridges CT1 and CT2. In the state where the roof 2 is opened, the cartridges CT1 and CT2 can be detached from and attached to a predetermined installation section of the lower body 3. If a photosensitive drum 23 is deteriorated or if toner ran out, for example, the cartridge CT1 or CT2 can be replaced with a new cartridge, or other expendable supplies can be provided as needed, thus achieving the machine maintenance operation of the printer device.

Today, color printer devices (color image formation devices) are widely used, and various color printing methods are employed. For example, according to one technique, a plurality of developing units are arranged adjacent to the circumferential surface of one photosensitive drum, and toner images are sequentially formed on the surface of the drum (technique (I)). There is another technique (II), which employs an intermediate transcription medium in a drum-like form. A plurality of image formation units are arranged in a predetermined direction, and toner images are sequentially output on one top of another on a paper so as to form an image (what is so-called a tandem-type printing technique).

In the above technique (I), it is necessary to use a large-sized photosensitive drum, and it is difficult to form an image formation section in one unit, resulting in low printing performance. In the above technique (II), because the intermediate transcription medium is used, the size of the printer device itself is formed large.

It is demanded that tandem-type color printer devices with an excellent shape can perform high-speed printing. In this type of printer device, image formation units of, for example, yellow (Y), magenta (M), cyan (C), and black (K) are used. Such image formation units are articles of consumption which are to be used up, thus need to be replaced with new ones periodically.

In the printer devices having the structure shown in FIGS. 13 and 14, the image formation unit is formed in the lower body 3. In this structure, the first cartridge CT1 and the second cartridge CT2 are arranged in the lower body 3. The fixation unit 14 is also arranged in the lower body 3. In the case where the printer device 1 is arranged on a warped surface of a table, etc., a slight twist occurs in the lower body 3. This slight twist has an effect on the image formation unit arranged in the lower body 3 and a conveyer mechanism for conveying papers. Especially, in a tandem-type color printer, it is important to adjust the printing positions of toner images of Yellow (Y), Magenta (M), Cyan (C), and Black (K). In the above-described structure, shear occurs in the printing, thus causing the printing quality to be deteriorated.

### SUMMARY OF THE INVENTION

The present invention has been made in consideration of the above problems.

It is accordingly an object of the present invention to provide a printer device performing high quality printing and having a frame connection structure for desirably maintaining the functions of engine parts of image formation units, etc. without any effect of unstable arrangement of the printer device which is caused by an external factor, such as a warped surface of a table on which the printer device is placed.

In order to accomplish the above object, according to an aspect of the present invention, there is provided a printer device, having framework including a plurality of framing members connected with each other, comprising: an image holding body;

writing means for writing an image in accordance with an image signal onto the image holding body;

image formation means for adhering a pigment to the image which is written onto the image holding body by the writing means; and

paper conveyer means for conveying a paper to transcription means for transcribing the pigment, which is adhered onto the image holding body by the image formation means, onto the paper, and

the plurality of framing members including

a lower frame which is arranged on a lower section of the printer device and adjacent to an installation surface of the printer device, and

a sub-frame which supports the image holding body and the writing means, and

the sub-frame being connected with the lower frame at three connection points, and being unlikely to be twisted even if the lower frame is twisted as a result of unstable arrangement of the lower frame.

In the above structure, the image holding body is a member for forming and retaining a toner image on a photosensitive drum. The writing means is means for optically writing an image from a printing head. The image formation means is developing means, such as a developing roller for forming a toner image on the surface of the image holding body. The paper conveyer means conveys papers output from a feeding cassette, etc. to the image holding body via a suspension roller. Further, the lower frame forms one of a plurality of frames, and supports the lower section of the printer device in a position adjacent to the printer. The sub-frame is separated from the upper body, and supports the image holding body and the writing means.

According to the structure, the sub-frame which is separated from the lower frame is likely to desirably function without any effect of a slight twist of the upper frame. In the three-point connection structure, wherein the lower frame and the sub-frame are connected at three connection points, the sub-frame hardly gets an effect of a positional deviation of the lower section of the printer device.

In the printer device having the above-described structure, the lower frame and the sub-frame are formed approximately in a rectangular shape, and

the lower frame and the sub-frame are connected with each other at two connection points on a predetermined side of the rectangular shape, and the lower frame and the sub-frame are connected with each other at one point on a side facing the predetermined side of the rectangular shape.

According to the above structure, the lower frame and the sub-frame are firmly connected with each other. At the same time, the position device of the lower section of the printer device hardly has an effect on the sub-frame.

The sub-frame further supports the paper conveyer means.

According to the above structure, the position of papers conveyed by the paper conveyer means and the position of the image holding body supported by the sub-frame are stably determined regardless of the position deviation of the lower section of the printer device.

The image holding body, the wiring means and the image formation means are incorporated with each other so as to form an image formation unit; and

the printer device is a tandem-type printer device including a plurality of image formation units respectively corresponding to a plurality of colors. Having applied the frame connection structure of the present invention into such a tandem-type color printer, the deviation occurring in a plurality of image components corresponding to toner colors can effectively be prevented. This results in high quality color printing.

According to the above-described frame connection structure of the printer device, even if the lower section of the printer device tilts over one side, the image formation units supported by the sub-frame can stably be operated. Therefore, in this structure, no deviation should occur in image components to be printed and the image components corresponding to the toner colors, thus providing high quality color printing.

### BRIEF DESCRIPTION OF THE DRAWINGS

The object and other objects and advantages of the present invention will become more apparent upon reading of the following detailed description and the accompanying drawings in which:

FIG. 1 is an outside perspective view of a printer device, according to one embodiment of the present invention, which is so-called a tandem-type color printer;

FIG. 2 is an outside perspective view of a state of the printer device of FIG. 1, wherein a front cover of the printer device is opened;

FIG. 3 is an exemplary cross sectional view of the internal structure of the printer device;

FIG. 4 is a perspective view of the frame connection structure of the printer device;

FIG. 5 is a perspective view for explaining the arrangement of a plurality of frames included in the printer device;

FIG. 6 is an assembly diagram for explaining the relationship between the main frame and the sub-frame of the printer device;

FIG. 7 is an outside perspective view for explaining a state of the printer device, wherein an upper body is opened by a link mechanism included in the printer device;

FIG. 8 is a schematic diagram of the link mechanism which is viewed from the left side surface of the printer device;

FIG. 9 is a schematic diagram of the link mechanism which is viewed from the right side surface of the printer device;

FIG. 10 is a schematic perspective view of the link mechanism which is taken away from the printer device;

FIG. 11 is a diagram showing a driving mechanism having a link structure in the printer device;

FIG. 12 is a perspective view showing the principal components of a main frame and a sub-frame in the frame connection structure of the printer device according to a modification of the present invention;

FIG. 13 is a diagram showing the entire structure of a monochrome printer device as a conventional printer device; and

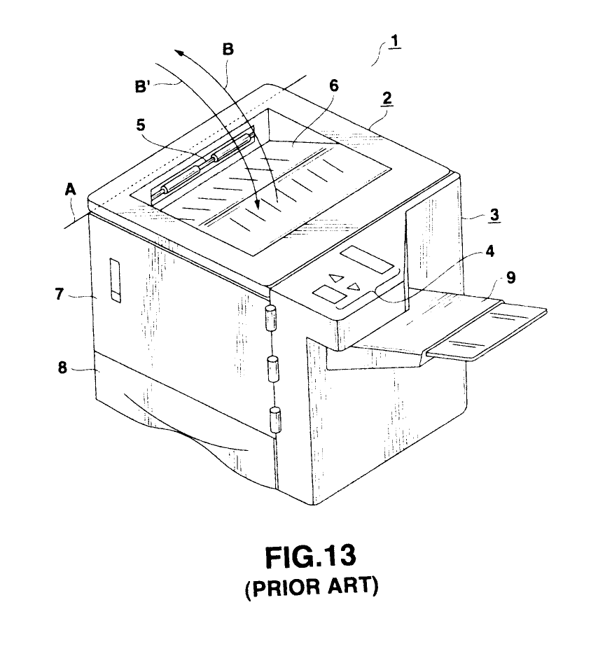

FIG. 14 is a diagram showing the internal structure of the monochrome printer device of FIG. 13.

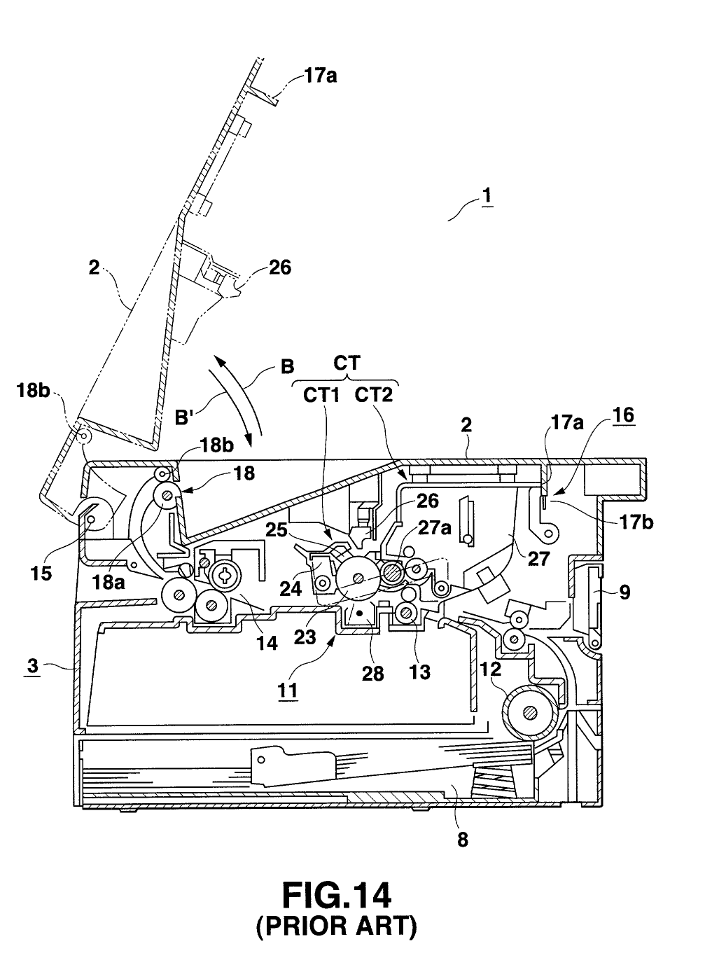

### DETAILED DESCRIPTION OF THE PREFERRED EMBODIMENT

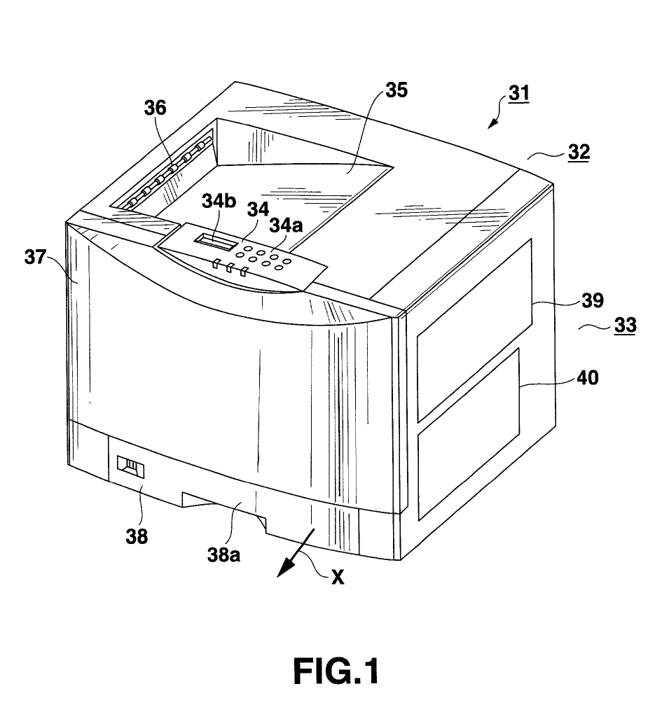

FIG. 1 is a diagram for explaining a frame connection structure of a printer device of this embodiment. The printer device of this embodiment is an example of a so-called tandem-type color printer for both-side printing. In the illustration, a printer device 31 is connected to a host apparatus, such as a personal computer or the like, via a non-illustrative cable.

The printer device 31 comprises an upper body 32 and a lower body 33. The upper body 32 includes an operational panel 34 and an output tray 35 for printing papers which is arranged on the surface of the upper body 32. The operational panel 34 comprises a key operational section 34a including a plurality of keys, and a liquid crystal display 34b for displaying information which is output under the control of a non-illustrative CPU. The output tray 35 accepts output papers, on which image data is printed by later-described image formation units, which are transported by the rotation of a paper outputting roller 36. Papers are subsequently output onto the output tray 35 one on top of another.

The lower body 33 includes a conveyer unit for both-side printing, as will be explained later, and a feeding cassette 38 which are installed in the lower body 33. After a non-illustrative lid arranged on the side surface of the printer device 31 is opened, for example, the conveyer unit can be detached from and attached to the lower body 33. The lower body 33 includes a front cover 37 which can be opened and closed in front of the lower body 33, and the feeding cassette 38 which are detachable from and attachable to the lower body 33. The front cover 37 is opened, while clearing any jams occurring in the printer device 31 or during the machine maintenance.

Arranged on the right-side surface of the lower body 33 are an installation section 39 for an MPF (Multi-Paper Feeder) tray and a cover 40. FIG. 1 shows the state of the printer device 31 in which the MPF tray is not installed in the installation section 39. The cover 40 is one prepared for checking a paper conveyer path, and is opened so as to carry out a maintenance operation for clearing a jam caused by a paper stacked somewhere inside the printer device 31.

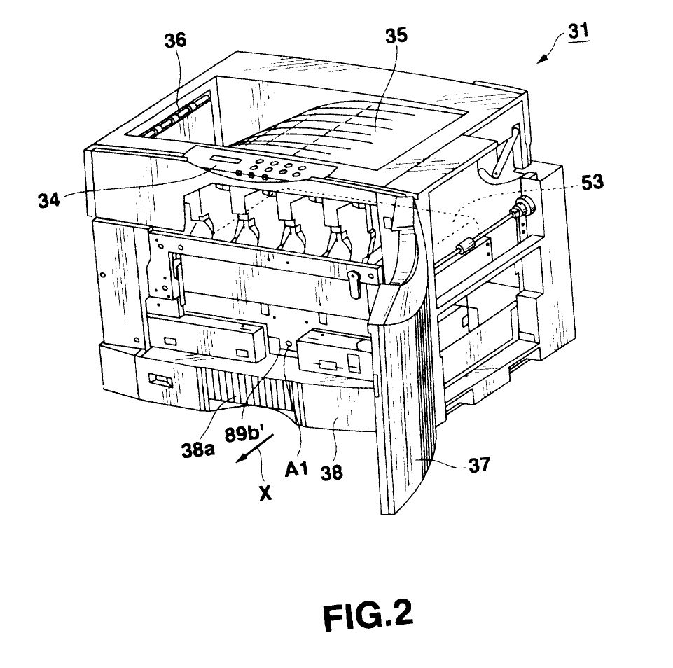

FIG. 2 is an outside perspective view of the printer device 31 of this embodiment, and shows a state in which the front cover 37 and the cover 40 are both opened. The feeding cassette 38 is included in the most lower stage of the printer device 31. When providing the feeding cassette 38 with paper, a knob 38a is pulled out, for example, thereby the feeding cassette 38 can be pulled out in an X-direction.

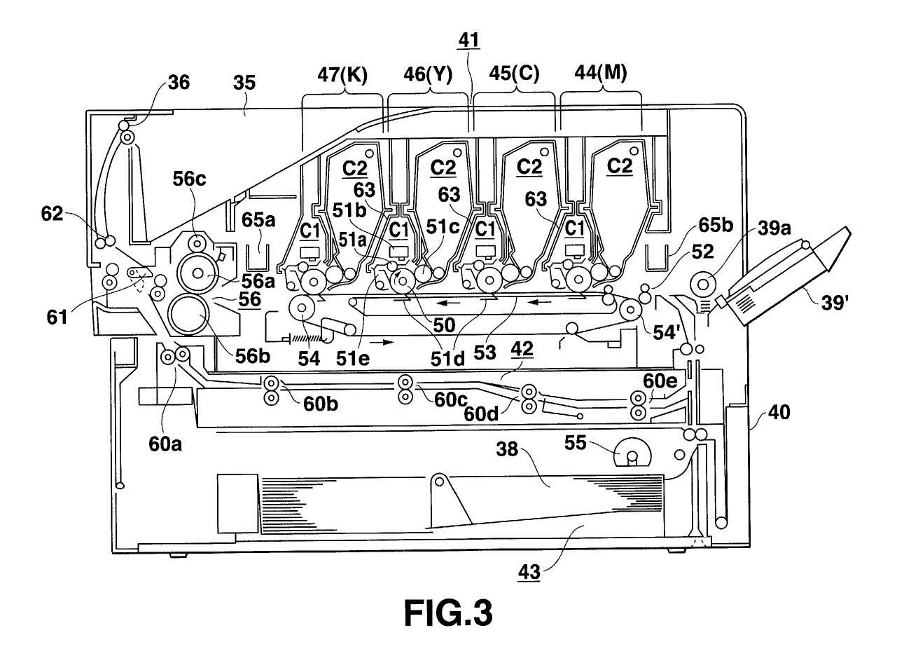

FIG. 3 is an exemplary cross sectional view for explaining the internal structure of the printer device 31 having the so-far described appearance. In the illustration, the printer device 31 comprises an image formation section 41, a conveyer unit 42 for both-side printing, and a paper feeding section 43, and the like. The image formation section 41 includes four image formation units 44 to 47 along the paper conveyer path. Those image formation units 44 to 47 include units for respective colors of magenta (M), cyan (C), yellow (Y) and black (K) sequentially in a direction from the right side to the left side of the printer device 31 in the illustration. The image formation units 44 to 46 for colors of (M), (C) and (Y) are prepared for color printing with subtractive mixture of colors. The image formation unit 47 for (K) is prepared for monochrome printing.

Each of the image formation units 44 to 47 includes a drum unit C1 and a toner unit C2. Each of the image formation units 44 to 47 has the same structure as each other, except the color of toner in the toner unit C2. Hence, in this embodiment, explanations will be made to the image formation unit 46 for (Y) by way of example. The drum unit C1 includes a photosensitive drum, a charger, and a cleaner. The toner unit C2 includes a developing roller, a toner, etc. The circumferential surface of the photosensitive drum 50 is formed of an organic optical-conductive material, for example. A charger 51a, a printing head 51b, a developing roller 51c, a transcription unit 51d, and a cleaner 51e are arranged adjacent to the photosensitive drum 50. The photosensitive drum 50 rotates in a direction as shown with an arrow (in a clockwise direction in the illustration). The circumferential surface of the photosensitive drum 50 is uniformly charged with an electric charge from the charger 51a. An electrostatic latent image is formed on the circumferential surface of the photosensitive drum 50 by optical writing based on printing information from the printing head 51b, thereby to form a toner image by the developing roller 51c. At this time, the toner image formed on the circumferential surface of the photosensitive drum 50 is formed with a toner of yellow (Y) contained in the image formation unit 46. The toner image thus formed on the circumferential surface of the photosensitive drum 50 reaches the transcription unit 51d along with the rotation of the photosensitive drum 50, and is transcribed onto a paper which is conveyed in accordance with a direction, shown with an arrow in the illustration, immediately blow the photosensitive drum 50.

The drum units C1 and the toner units C2 of the image formation units 44 to 47 are detachable from and attachable to their corresponding units. This can be done with a unit installation section 63 which is included in each of the image formation units 44 to 47. The unit installation section 63 is formed in such a rail-like shape that its corresponding drum unit C1 and toner unit C2 slide approximately in an horizontal direction and are detached from and attached to the unit. The printing head 51b is arranged inside the unit installation section 63.

A printing paper is conveyed from the feeding cassette 38 included in the feeding section 43, throughout a suspension roller 52, a conveyer belt 53, a driving roller 54 and a driven roller 54′. The paper conveyed from the feeding cassette 38 by the rotation of a feeding roller 55 is sent to the suspension roller 52 and further onto the conveyer belt 53 at an appropriate timing the toner image reaches the paper, and reaches the transcription unit 51d. The toner image is transcribed onto a paper by the transcription unit 51d. The paper onto which the toner image is transcribed is conveyed on the conveyer belt 53 in the arrow direction (from the right side toward the left side in the illustration), in accordance with the movement of the conveyer belt 53. Heat fixation treatment is performed for thus conveyed paper by a fixation unit 56 which is prepared as heat fixation means.

On the paper, not only the toner image of yellow (Y), but also toner images of other colors of magenta (M) and cyan (C), which are transcribed by their corresponding drum units C1 and toner units C2, are transcribed, thereby to accomplish color printing based on the subtraction mixture of colors.

Not only those papers conveyed from the feeding cassette 38, but also any paper supplied from an MPF tray 39′ can be used. In this case, the paper supplied from the MPF tray 39′ is conveyed by a feeding roller 39a, and the printing is performed according to the above process.

The fixation unit 56 comprises a heat roller 56a, a press roller 56b, and a cleaning roller 56c. A paper P is sandwiched between the heat roller 56a and the press roller 56b so as to be conveyed. During this time, the toner image having a plurality of colors and transcribed on the paper melts and is fixed on the paper P with heat. The cleaning roller 56c has a function for applying oil onto the heat roller 56a and a function for removing toner remaining on the heat roller 56a. The paper, onto which the toner image is fixed by the fixation unit 56 is conveyed upward or in a leftward direction in the illustration via a switching plate 61.

The conveyer unit 42 for both-side printing is detachable from and attachable to the printer device 31, and installed in the printer device 31 when to perform both-side printing. The conveyer unit 42 for both-side printing includes a plurality of conveyer rollers 60a, 60b, 60c, 60d, and 60e. In the case of both-side printing, the paper is once conveyed upward by the switching plate 61. Then, when the last end of the paper reaches a conveyer roller 62, for example, the paper is suspended, and is conveyed in the reverse direction. Under this control, the paper is conveyed in a downward direction by the switching plate 61, which is set in the position shown with a broken line in FIG. 3. Then, the paper is sent to the paper conveyer path of the conveyer unit 42 for both-side printing, and conveyed through the conveyer rollers 60a to 60e so as to reach the suspension roller 52. After this, the paper is sent to the transcription unit 51d at a timing the toner image reaches the paper, so that the toner image is transcribed onto the back surface of the paper.

In FIG. 3, the position of an FR frame 65 (including the FR frames 65a and 65b arranged on the right and left sides of the printer device 31) is shown.

In the printer device 31 of this embodiment, the upper body 32 is opened and closed in a horizontal direction with respect to the lower body 33, so as to carry out a maintenance operation.

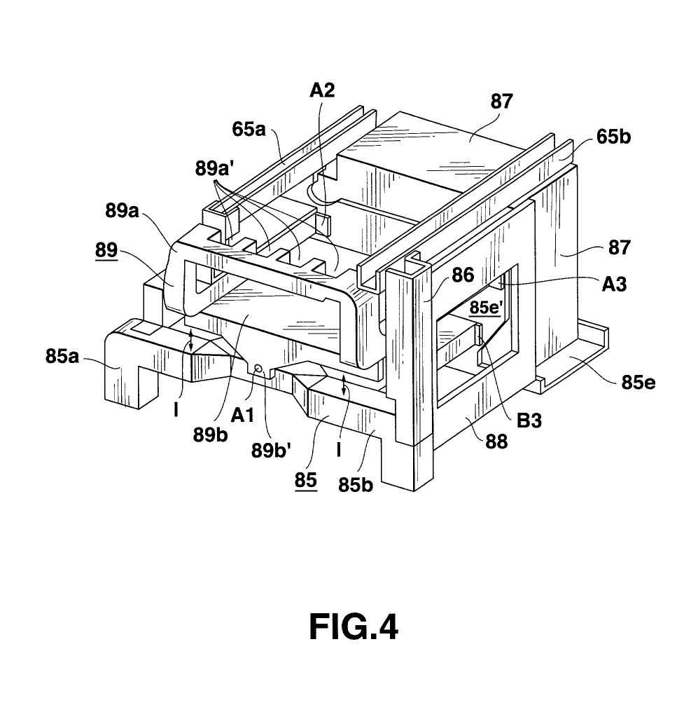

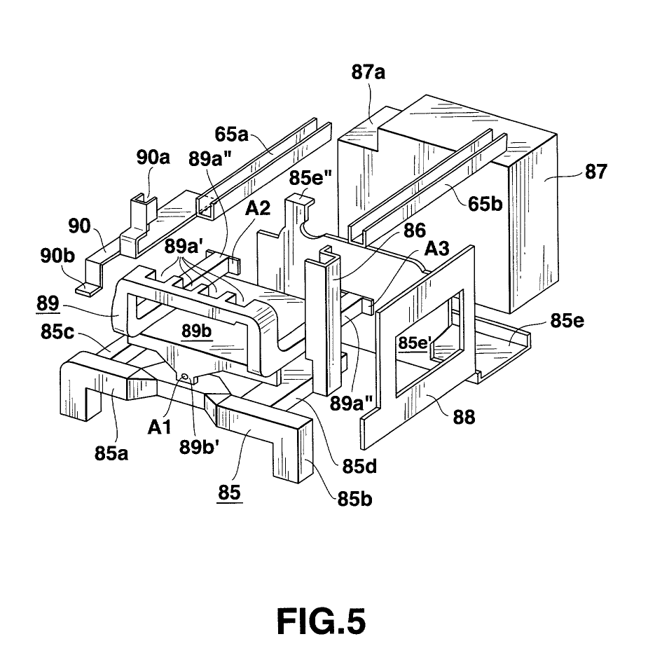

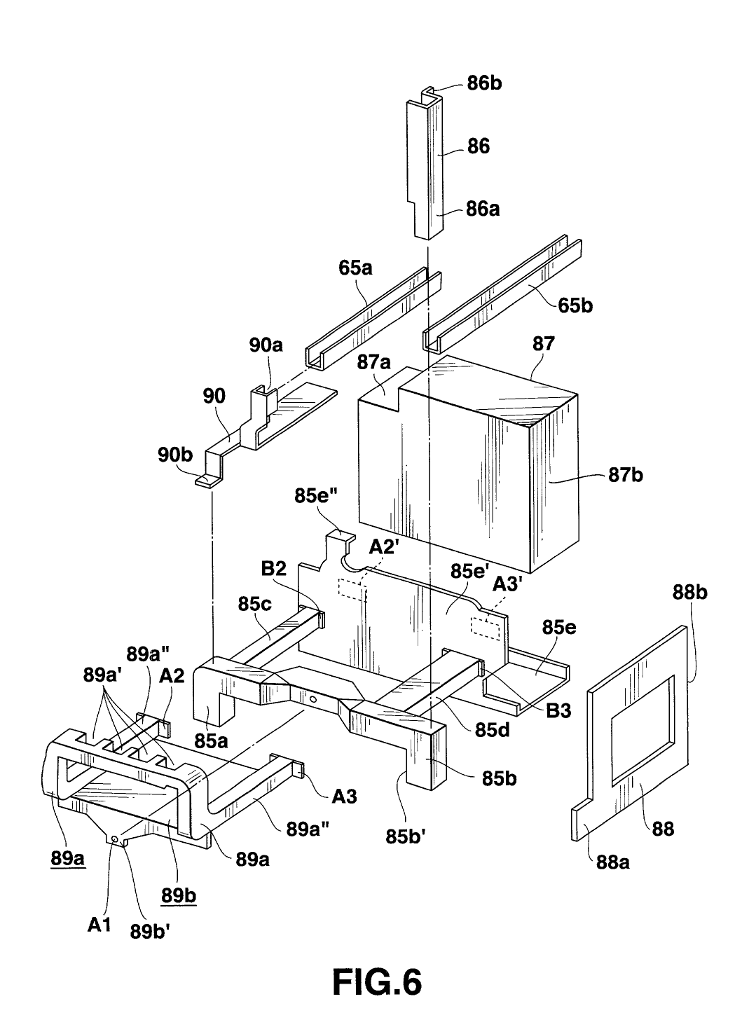

FIG. 4 is a diagram for explaining a frame connection structure of the printer device 31 according to this embodiment. FIG. 5 is a diagram for explaining the arrangement of a plurality of frames. FIG. 6 is an assembly diagram for explaining the relationship between the main frame and the sub-frame for clear description thereof. In each of FIGS. 4, 5 and 6, the main frame, which forms the lower frame of the printer device 31, is denoted by the reference numeral 85. A plurality of frames 85a, 85b, 85c, 85d, 85e, etc. are fixed using either technique of welding, clamping, pressure-fixing, etc.

As shown in FIG. 6, the frames 85a and 85b are incorporated with each other so as to form the front frame, while the frames 85c and 85d are incorporated with each other. One ends of the respective frames 85c and 85d, as bent sections B2 and B3, are fixed on a standing edge 85e′. A frame 86 for installing an FR frame 65b is fixed on the frame 85b, whereas a frame 90 for installing an FR frame 65a is fixed on the frame 85a. As illustrated in FIG. 6, a lower end 86a of the frame 86 is fixed on the frame 85b. One end of the FR frame 65a is fixed onto a bent-concave section 90a of the frame 90. A lower bent section 90b of the frame 90 is fixed onto an upper surface of the frame 85a. The above fixing of the frames onto their corresponding frames are performed using either technique of welding, clamping, etc.

An electric equipment box 87 installed behind the printer device contains a control circuit or a source circuit and a driving transmission mechanism, etc. of the printer device 31. This electric equipment box 87 is fixed on the frame 85e which is included in the main frame 85. A side plate 88 of the printer device 31 is also fixed on the main frame 85. In more particular, the electric equipment box 87 is placed on the bottom surface of the frame 85e. An upper bent section 85e″ of the frame 85e and the other end of the FR frame 65a are placed on a step 87a of the electric equipment box 87. A lower convex section 88a of the side plate 88 is fixed onto an inner surface of leg 85b′ of the frame 85b, while a side section 88b is fixed onto a side section 87b of the electric equipment box 87. A bent section 86b of the frame 86 is fixed onto one end (front end) of the FR frame 65b, while the other end (distal end) of the FR frame 65b is fixed onto the upper surface of the electric equipment box 87. In the above structure, the plurality of frames, except the sub-frame 89, are incorporated with each other so as to form the lower frame of the printer device.

The sub-frame 89 is fixed above the main frame 85 so as to be included in the lower frame of the printer device, in a three-point connection manner. The sub-frame 89 is formed of a frame section 89a and a plate section 89b, as seen from FIG. 6. The frame section 89a includes four concave sections 89a′ in the upper section thereof. The image formation units 44 to 47 are fixed into the concave sections 89a′, respectively. That is, the image formation units 44 to 47 are positioned and supported by the sub-frame 89. The above-described conveyer belt 53 is arranged on the plate section 89b, and fixed thereinto.

In the three-point connection manner, the main frame 85 and the sub-frame 89 are connected and fixed at three points of an A1 point, an A2 and an A3 shown in FIGS. 4 to 6. The A1 point is a point at which a bent tip 89b′ of the plate section 89b is fixed onto the front surface of the main frame 85. The A2 point and the A3 point are points at which the frame section 89a is fixed on the frame 85e. Particularly, the A2 point and the A3 point are prepared for fixing elongated sections 89a′, which are elongated backward from the frame section 89a, onto the positions denoted by broken lines A2′ and A3′ of the standing edge 85e′. As illustrated in FIG. 4, there is a certain interval, denoted by a reference mark 1 (actually several mm), between the frames 85a, 85b and the plate section 89b of the sub-frame 89, with due regard to a slight twist of the main frame 85. Thus, the front section of the sub-frame 89 and the main frame 85 are slidable centrically about the A1 point.

Accordingly, in the printer device 1 of this embodiment which is in an operational state, the image formation units 44 to 47 are supported by the sub-frame 89. The conveyer belt 53 is arranged on the side of the sub-frame 89. The sub-frame 89 is separated from the main frame 85 forming a lower section of the printer device 31. Hence, a slight twist of the lower section hardly has an effect on the sub-frame 89, when the lower frame of the printer device 31 is arranged on a warped surface of a table, etc.

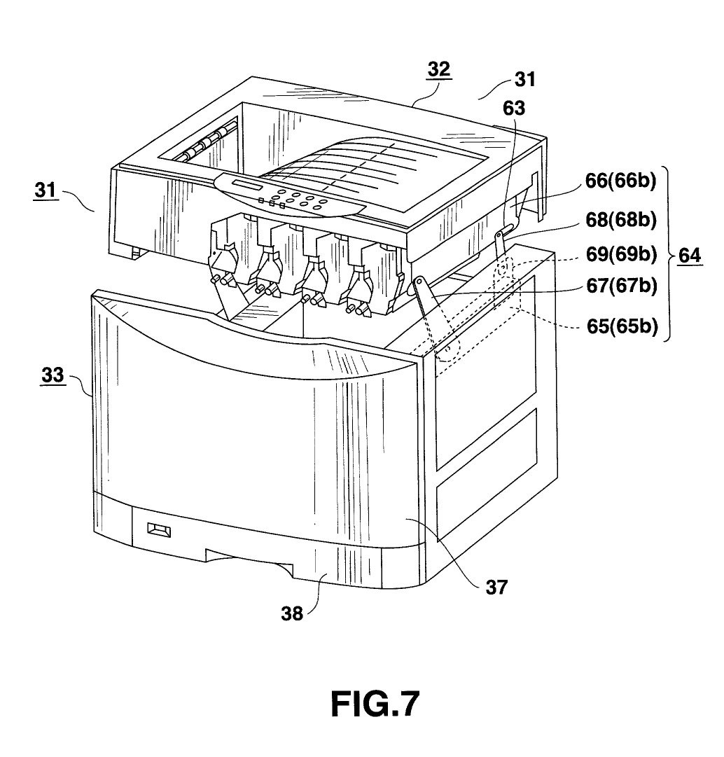

The upper body 32 can be opened away from the lower body 33 having the above-structured link mechanism. FIG. 7 is an outside perspective view of the printer device 32, wherein the upper body 32 is opened. As shown in FIG. 7, the upper body 32 is opened away from the lower body 33 in a horizontal direction by the link mechanism 64 included in the printer device 31.

The link mechanism 64 comprises a link frame 66, an F arm 67, an R arm 68, a stay 69, and an FR frame 65, on both sides of the printer device 31. One ends of the respective F arm 67 and R arm 68 are connected to and rotatively support the link frame 66 arranged on the upper body 32. The other end of the F arm 67 is connected to an rotatively supports the FR frame 65 arranged on the lower body 33. The other end of the R arm 68 is connected to and rotatively supports the stay 69 which is fixed on the FR frame 65. In this structure, the upper body 32 is opened in parallel with respect to the lower body 33, and is gradually moved backward with respect to the lower body 33.

In FIG. 7, those sections included in the link mechanism 64 only on the right side of the printer device 31 are denoted by reference numerals, for the sake of simple illustration. In the following explanations, those sections in the link mechanism on the left side of the printer device 31 are denoted by reference numerals with “a”, while those sections in the link mechanism on the right side thereof are denoted by reference numerals with “b”. Hence, in FIG. 7, the link frame is denoted by 66b, the F is denoted by 67b, the R arm is denoted by 68b, the stay is denoted by 69b, and the FR frame is denoted by 65b, which are included in the link mechanism on the right side of the printer device.

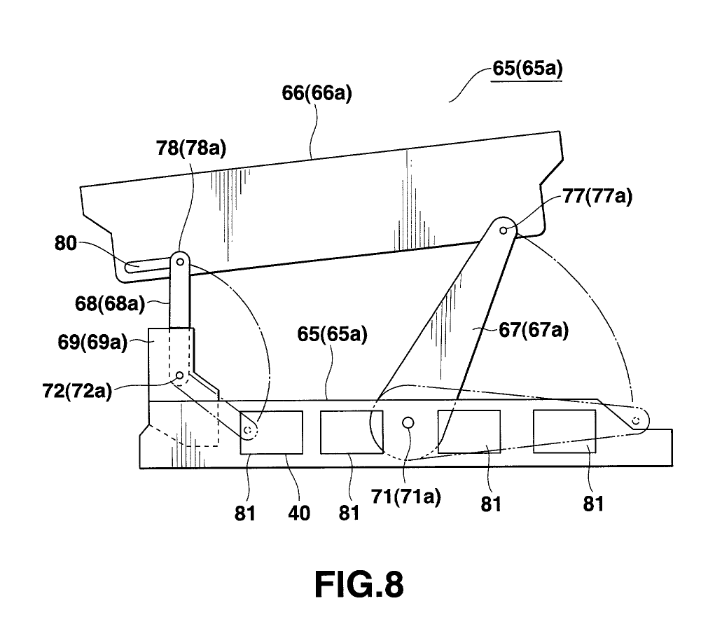

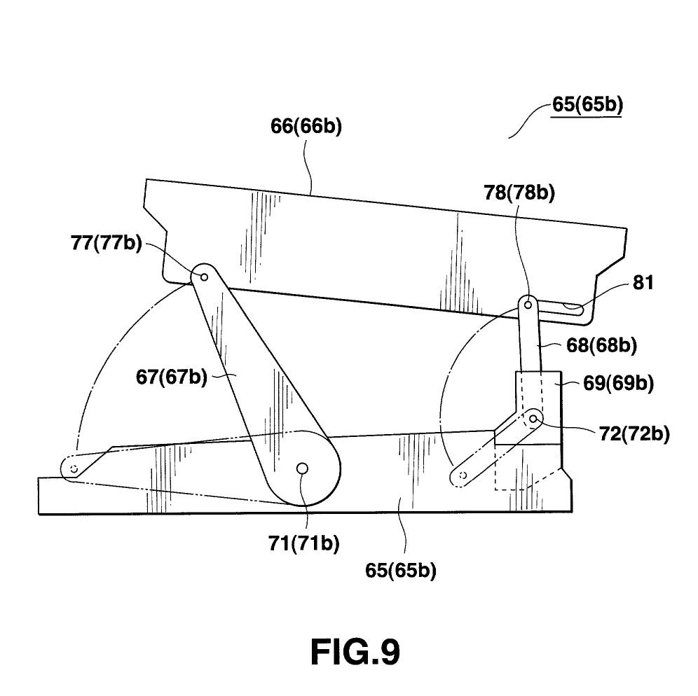

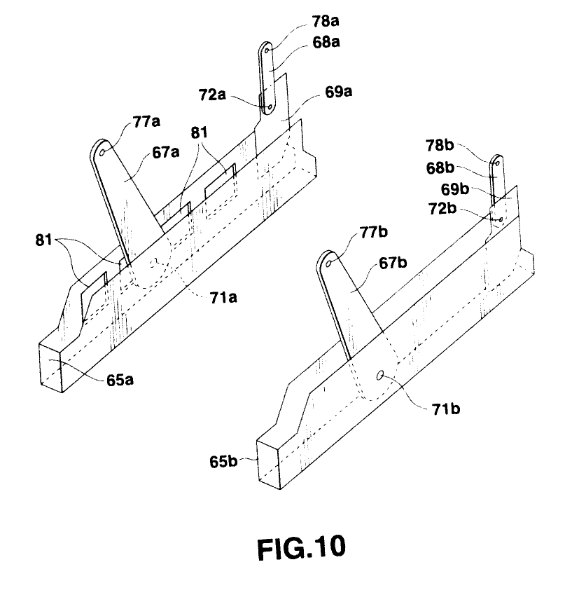

FIGS. 8 and 9 are schematic diagrams of the link mechanism. Particularly, FIG. 8 shows a schematic diagram of the link mechanism viewed from the left side-surface thereof, and FIG. 9 is a schematic diagram of the link mechanism viewed from the right side-surface thereof. FIG. 10 is a perspective view of the link mechanism. In FIGS. 8 to 10, the link frame 66 (66a, 66b), the F arm 67 (67a, 67b), the R arm 68 (68a, 68b), the stay 69 (69a, 69b), and the FR frame 65 (65a, 65b) are the principal components of the link mechanism. In FIG. 10, the link frame 66 (66a, 66b) is not illustrated.

In FIGS. 8 and 9, the F arm 67 (67a, 67b) and the R arm 68 (68a, 68b) illustrated with straight lines are shown in their corresponding positions when the upper body 32 is opened. At this time, the upper body 32 is retained to be opened approximately in parallel with respect to the lower body 33. The F arm 67 (67a, 67b) and the R arm 68 (68a, 68b) illustrated with double dot chain lines are shown in their corresponding positions when the upper body 32 is shifted back toward the lower body 33 so as to be closed.

A supporting section 71 (71a, 71b) rotatively supports the F arm 67 (67a, 67b) and the FR frame 65 (65a, 65b), while a supporting section 72 (72a, 72b) rotatively supports the R arm 68 (68a, 68b) and the stay 69 (69a, 69b). A supporting section 77 (77a, 77b) rotatively supports the F arm 67 (67a, 67b) and the link frame 66 (66a, 66b), while a supporting section 78 (78a, 78b) rotatively supports the R arm 68 (68a, 68b) and the link frame 66 (66a, 66b).

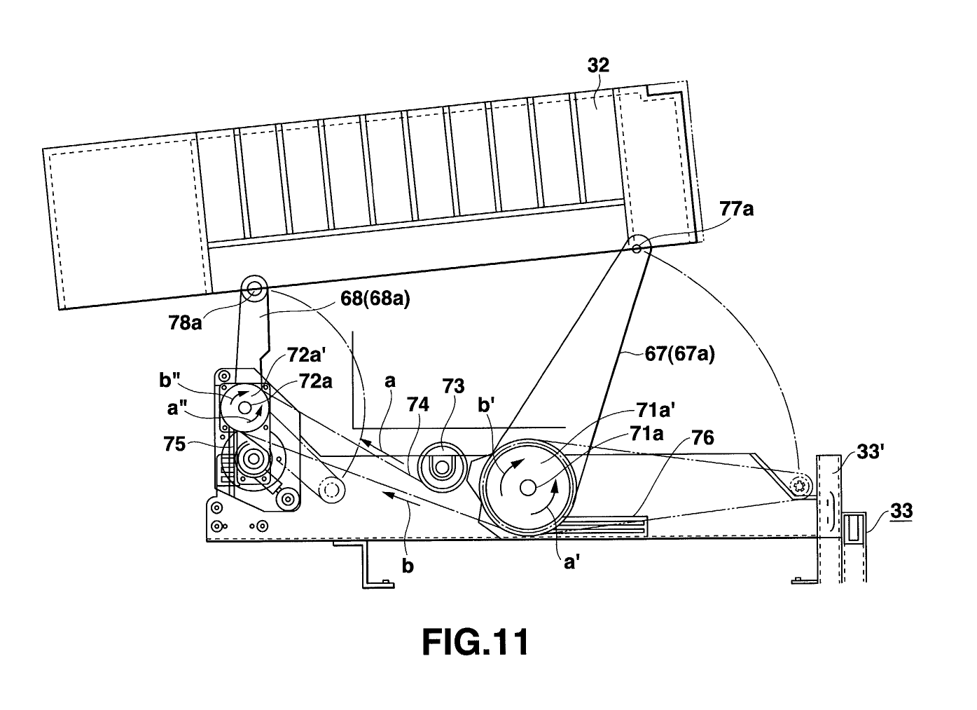

FIG. 11 is a diagram for explaining the driving mechanism of the link mechanism. As shown in FIG. 11, the link mechanism is symmetrical. FIG. 11 shows the driving mechanism of the link mechanism which corresponds to that shown in FIG. 8. The front side-surface of the printer device 31 is shown on the right side in the illustration of FIG. 11. As explained above, the F arm 67a is rotatively supported by the supporting section 71a, and fixed by a rotational gear 71a′. The R arm 68a is rotatively supported by the supporting section 72a, and fixed by a rotational gear 72a′. In this structure, the F arm 67a and the rotational gear 71a′ rotate as a unit, and the R arm 68a and the rotational gear 72a′ rotate as a unit.

An intermediate pulley 73 intermediates between the rotational gears 71a′ and 72a′. A gear belt 74 is built between the rotational gears 71a′ and 72a′ via the intermediate pulley 73. The intermediate pulley 73 is to give a predetermined level of tension to the gear belt 74.

The rotational gear 72a′ is engaged with a rotator 75 having a damper mechanism. This rotator 75 includes an oil damper, and has a function for controlling a sudden fall of the upper body 32 according to the law of gravitation so as to make the upper body 32 smoothly fall. The upper body 32 is released up with a spring 76 so as to be opened. One end of this spring 76 is fixed by a casing 33′ of the lower body 33, and wound in a few rounds inside the rotational gear 71a′. The other end of the spring 76 is fixed in a hole (not illustrated) formed in the F arm 67a. The additional tension of the spring 76 causes the rotational gear 71a′ to rotate in an a′-direction denoted by an arrow a′, so that the upper body 32 is released up.

In more particular, when the rotational gear 71a′ rotates in the a′-direction, the F arm 67a is rotated in the same direction. At the same time, the gear belt 74 rotates in an a-direction denoted by an arrow a, and the rotational gear 72a′ rotates in an a″-direction denoted by an arrow a″, and the R arm 68a is rotated in the same a″-direction. The link mechanism functions by the above-described driving mechanism. Then, the F arm 67a and the R arm 68a are rotated in accordance with the rotational tracks, shown with a chain dot line in the illustration, causing the upper body 32 to be shifted up.

The state, where the upper body 32 is shifted back toward the lower body 33 so as to be closed, is illustrated in FIGS. 1 to 3. The plate section 89b of the sub-frame 89 is positioned below the carrier belt 53, which is shown with a broken line in FIG. 2. In the state where the upper body 32 is shifted backward toward the lower body 33, the image formation units 44 to 47 (drum unit C1, toner unit C2) are engaged with the concave section 89a′ formed in the sub-frame 89. The main frame 85 and the sub-frame 89 are connected in the three-point connection structure. In this structure, when the printer device 31 is placed on a warped surface of a table, etc., even the main frame 85 is slightly twisted, the sub-frame 89 is not twisted. Thus, no twist should occur in the sub-frame 89. In addition, the image formation units 44 to 47 arranged around the sub-frame 89 and the carrier belt 53 should not mechanically be deviated.

In the above-described embodiment, as shown in FIGS. 4 to 6, the main-frame 85 and the sub-frame 89 are connected with each other at the three points, A1, A2 and A3. The explanations have been made to the case where the bent tip 89b′ of the plate section 89b in the sub-frame 89 is fixed on the front surface of the main frame 85 at the point A1. However, the connection structure is not limited to the above.

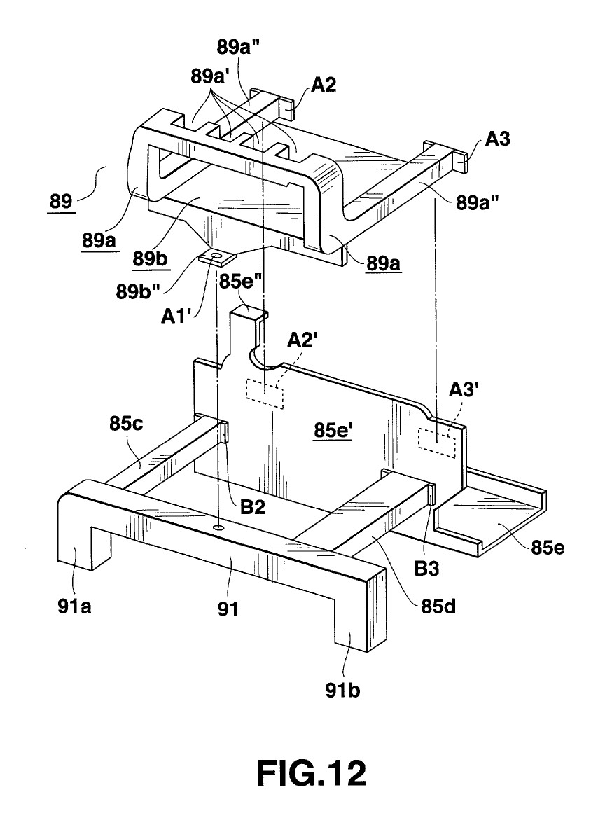

FIG. 12 is a perspective view showing the principal components of the main frame and the sub-frame in the frame connection structure of a printer device according to a modification of the present invention. FIG. 12 shows the relationship between the main frame and the sub-frame included in the printer device of the modification. In the illustration, the same reference numerals are attached to the same component parts of the printer device illustrated in FIGS. 4 to 6. In FIG. 12, those distinctive features in the structure of the printer device from those of the structure of the printer device according to the above-described embodiment are: that a front frame 91 forming the main frame is formed in a straight shape without any unevenness; and that a bent tip 89b″ of the plate section 89b in the sub-frame 89 is further bent in a horizontal direction. Legs 91a and 91b of the front frame 91 correspond to the frames 85a and 85b illustrated in FIGS. 4 to 6. The bent tip 89b″ is fixed on the upper surface of the front frame 91. The installation of such component parts of the printer device are performed using a welding or clamping technique. In this structure, even a slight twist occurs in the main frame, the sub-frame 89 should not have such a slight twist.

In the above-described embodiment, the main frame 85 is fixed onto the sub-frame 89 at the three positions of A1 (A1′) to A3 in the three-point connection structure. However, the main frame 85 may be fixed onto the sub-frame 89 at any other three positions.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-24651 filed on Feb. 2, 2000, and including specification, claims, drawings and summary. The disclosure of the above Japanese Patent Application is incorporated herein by reference in its entirety.

What is claimed is:

1. A printer device, having framework including a plurality of framing members connected with each other, comprising:
an image holding body;
writing means for writing an image in accordance with an image signal onto said image holding body;
image formation means for adhering a pigment to the image which is written onto said image holding body by said writing means; and
paper conveyer means for conveying a paper to transcription means for transcribing the pigment, which is adhered onto said image holding body by said image formation means, onto the paper, and
said plurality of-framing members including
a lower frame which is arranged on a lower section of said printer device and adjacent to an installation surface of said printer device, and
a sub-frame which supports said image holding body and said writing means, and
said sub-frame being connected with said lower frame at three connection points, and being unlikely to be twisted even if said lower frame is twisted as a result of unstable arrangement of the lower frame.

2. The printer device according to claim 1, wherein:
said lower frame and said sub-frame are formed approximately in a rectangular shape; and
said lower frame and said sub-frame are connected with each other at two connection points on a predetermined side of the rectangular shape, and said lower frame and said sub-frame are connected with each other at one point on a side facing the predetermined side of the rectangular shape.

3. The printer device according to claim 2, wherein said sub-frame further supports said paper conveyer means.

4. The printer device according to claim 3, wherein:
said image holding body, said wiring means and said image formation means are incorporated with each other so as to form an image formation unit; and
said printer device is a tandem-type printer device including a plurality of image formation units respectively corresponding to a plurality of colors.

5. The printer device according to claim 1, wherein said sub-frame further supports said paper conveyer means.

6. The printer device according to claim 5, wherein:
said image holding body, said writing means and said image formation means are incorporated with each other so as to form an image formation unit; and
said printer device is a tandem-type printer device including a plurality of image formation units respectively corresponding to a plurality of colors.
